(19) United States
(12) Patent Application Publication
(10) Pub. No.: US 2020/0019630 A1
(43) Pub. Date: Jan. 16, 2020

(54) COMBINING DATABASE RECORDS USING STREAM PROCESSING AND INVERTED INDEXING

(71) Applicant: salesforce.com, inc., San Francisco, CA (US)

(72) Inventors: Yu Wu, San Francisco, CA (US); Guillaume Le Stum, San Francisco, CA (US); Srikara Rao, San Francisco, CA (US)

(73) Assignee: salesforce.com, inc., San Francisco, CA (US)

(21) Appl. No.: 16/036,755

(22) Filed: Jul. 16, 2018

(51) Int. Cl. G06F 17/30; G06F 7/08

(52) U.S. Cl. CPC G06F 17/30321; G06F 7/08; G06F 17/30516

(57) ABSTRACT

Embodiments of the present disclosure relate to combining database records using stream processing and inverted indexing. Other embodiments may be described and/or claimed.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

Embodiments of the present disclosure relate to combining database records using stream processing and inverted indexing. Other embodiments may be described and/or claimed.

### BACKGROUND

Database systems provide a variety of different operations for processing datasets. One of the most used operations is known as a “join” operation (also sometimes referred to as an “augment operation,” or an “augment transformation”), which combines data from one dataset with data from another dataset. Two datasets being combined using a join/augment operation may be denoted as “left” and “right” datasets, though other terms may be used to describe the datasets.

For conventional database systems, join/augment operations face a number of issues with regards to efficiency. In some systems, for example, the datasets being combined are loaded into random-access memory (RAM) in their entirety and processed (e.g., using hashmap-based algorithms), which can be extremely memory-intensive, particularly for large datasets. In other cases, conventional database systems performs a series of random read operations to process the datasets from a secondary storage medium (such as a hard drive), which may be time consuming with large datasets, and can result in a condition known as “page thrashing,” where the database system runs out of virtual memory resources and the performance of the system is significantly degraded. Embodiments of the present disclosure address these and other issues.

### BRIEF DESCRIPTION OF THE DRAWINGS

The included drawings are for illustrative purposes and serve to provide examples of possible structures and operations for the disclosed inventive systems, apparatus, methods and computer-readable storage media. These drawings in no way limit any changes in form and detail that may be made by one skilled in the art without departing from the spirit and scope of the disclosed implementations.

FIG. 1A is a block diagram illustrating an example of an environment in which an on-demand database service can be used according to various embodiments of the present disclosure.

FIG. 1B is a block diagram illustrating examples of implementations of elements of FIG. 1A and examples of interconnections between these elements according to various embodiments of the present disclosure.

FIG. 2 is an example of a dataset in table format according to various embodiments of the present disclosure.

FIG. 3 illustrates an example of a data structure storing the data of the data set depicted in FIG. 2 according to various aspects of the present disclosure.

FIG. 4 is a flow diagram illustrating an example of a process according to various embodiments of the present disclosure.

### DETAILED DESCRIPTION

Examples of systems, apparatuses, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B or C” is intended to include the possibilities of “A,” “B,” “C,” “A and B,” “B and C,” “A and C” and “A, B and C.”

Some implementations described and referenced herein are directed to systems, apparatus, computer-implemented methods and computer-readable storage media for combining database records using stream processing and inverted indexing.

### I. System Examples

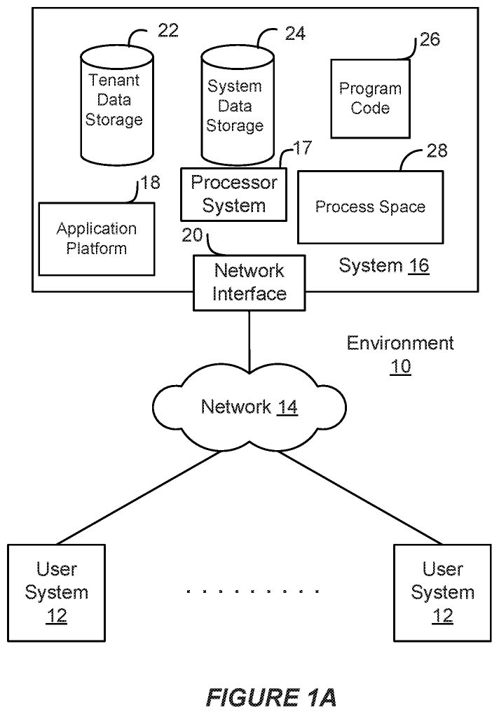

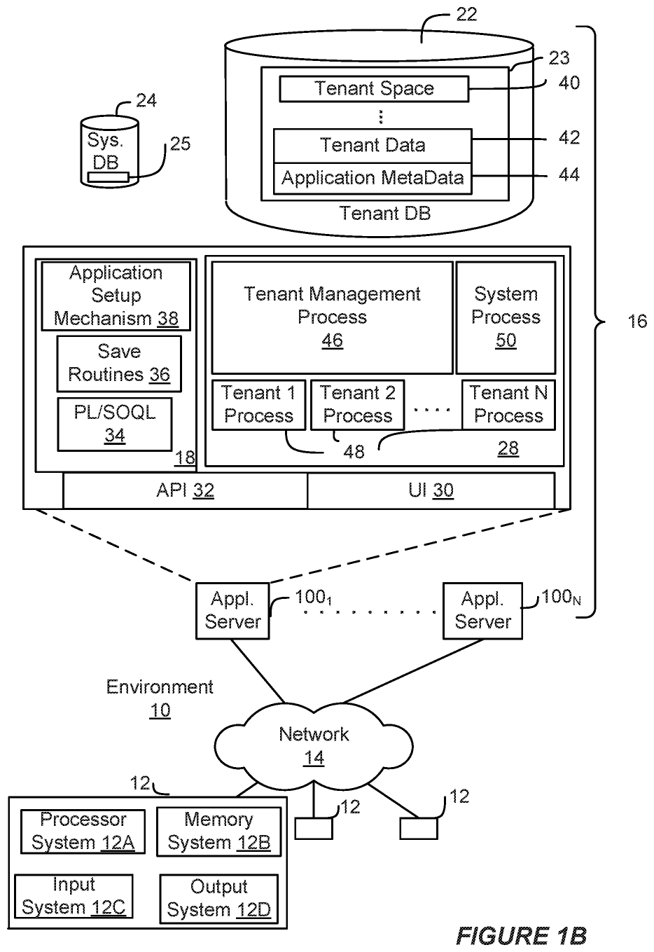

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Apple's Safari, Google's Chrome, Opera's browser, or Mozilla's Firefox browser, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

FIG. 1B shows a block diagram with examples of implementations of elements of FIG. 1A and examples of interconnections between these elements according to some implementations. That is, FIG. 1B also illustrates environment 10, but FIG. 1B, various elements of the system 16 and various interconnections between such elements are shown with more specificity according to some more specific implementations. Additionally, in FIG. 1B, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application servers 1001-100N. Each application server 100, also referred to herein as an “app server”, is configured to communicate with tenant database 22 and the tenant data 23 therein, as well as system database 24 and the system data 25 therein, to serve requests received from the user systems 12. The tenant data 23 can be divided into individual tenant storage spaces 40, which can be physically or logically arranged or divided. Within each tenant storage space 40, user storage 42 and application metadata 44 can similarly be allocated for each user. For example, a copy of a user's most recently used (MRU) items can be stored to user storage 42. Similarly, a copy of MRU items for an entire organization that is a tenant can be stored to tenant storage space 40.

The process space 28 includes system process space 102, individual tenant process spaces 48 and a tenant management process space 46. The application platform 18 includes an application setup mechanism 38 that supports application developers' creation and management of applications. Such applications and others can be saved as metadata into tenant database 22 by save routines 36 for execution by subscribers as one or more tenant process spaces 48 managed by tenant management process 46, for example. Invocations to such applications can be coded using PL/SOQL 34, which provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 44 for the subscriber making the invocation and executing the metadata as an application in a virtual machine.

The system 16 of FIG. 1B also includes a user interface (UI) 30 and an application programming interface (API) 32 to system 16 resident processes to users or developers at user systems 12. In some other implementations, the environment 10 may not have the same elements as those listed above or may have other elements instead of, or in addition to, those listed above.

Each application server 100 can be communicably coupled with tenant database 22 and system database 24, for example, having access to tenant data 23 and system data 25, respectively, via a different network connection. For example, one application server 1001 can be coupled via the network 14 (for example, the Internet), another application server 100N-1 can be coupled via a direct network link, and another application server 100N can be coupled by yet a different network connection. Transfer Control Protocol and Internet Protocol (TCP/IP) are examples of typical protocols that can be used for communicating between application servers 100 and the system 16. However, it will be apparent to one skilled in the art that other transport protocols can be used to optimize the system 16 depending on the network interconnections used.

In some implementations, each application server 100 is configured to handle requests for any user associated with any organization that is a tenant of the system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, system 16 can be a multi-tenant system in which system 16 handles storage of, and access to, different objects, data and applications across disparate users and organizations.

In one example of a storage use case, one tenant can be a company that employs a sales force where each salesperson uses system 16 to manage aspects of their sales. A user can maintain contact data, leads data, customer follow-up data, performance data, goals and progress data, etc., all applicable to that user's personal sales process (for example, in tenant database 22). In an example of an MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 16 also can maintain system level data usable by multiple tenants or other data. Such system level data can include industry reports, news, postings, and the like that are sharable among tenants.

In some implementations, the user systems 12 (which also can be client systems) communicate with the application servers 100 to request and update system-level and tenant-level data from the system 16. Such requests and updates can involve sending one or more queries to tenant database 22 or system database 24. The system 16 (for example, an application server 100 in the system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### II. Combining Database Records Using Stream Processing and Inverted Indexing

An inverted index (also referred to as a “postings file” or “inverted file”) is an index data structure storing a mapping from content in a dataset, such as words (e.g., in the form of a text string), numbers (e.g., a numeric value) or combinations thereof (e.g., an alphanumeric string) to the respective locations of the content in a database file.

As described in more detail below, embodiments of the present disclosure may use inverted index data structures to map dimension string values to integers, such that the integers may be used to represent both numeric content and string content. Database systems implementing embodiments of the present disclosure may thus process relatively shorter lists of integers representing much longer strings, thereby allowing the database system to perform a relatively faster and less-memory-intensive stream-processing of datasets compared to conventional systems.

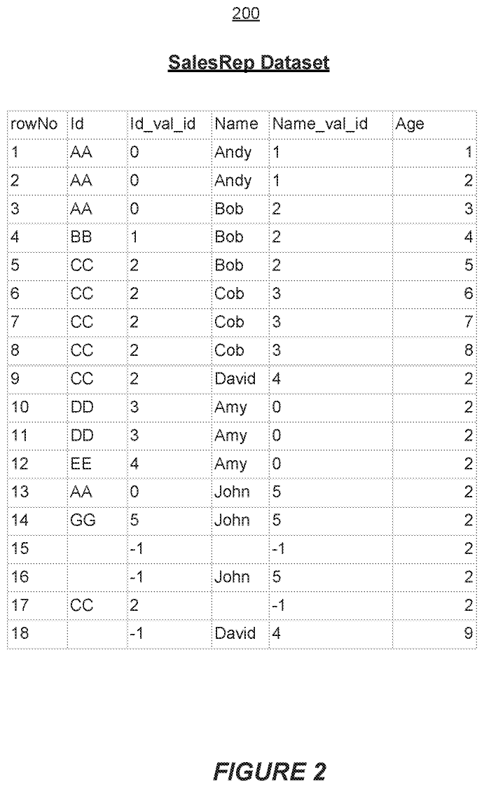

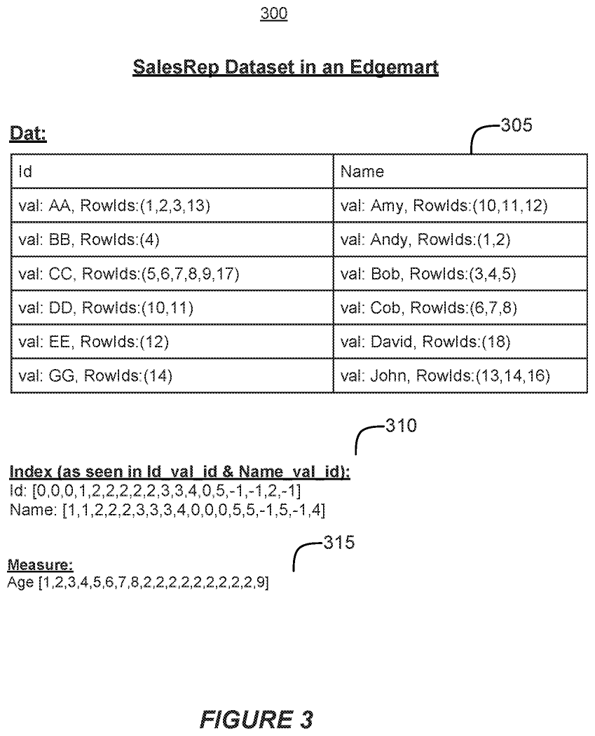

Embodiments of the present disclosure may be implemented in conjunction with datasets in a variety of formats. FIG. 2 illustrates an example of a dataset in tabular format. In this example, dataset 200 includes columns labeling different data fields, with each row representing a separate data element. The dataset 200 in FIG. 2 may be represented in the form of a data structure, such as an “edgemart” data structure provided by Salesforce.com, Inc. of San Francisco, Calif. as depicted in FIG. 3.

In one example, the edgemart data structure contains two “dimensions” and one “measure” as follows:

### Dimension

dat: [ ] {Value string, RowIds [ ]int}
   in ascending Value order;
   row ids are in ascending order in a compressed format (“byte array”);
   value id is implicit (array index, zero based unlike row id).
index: [ ] {ValueId int}
   row id is implicit (array index +1);
   when a row has a null value ValueId is set to −1 in index;
   dat format allows a row to have multiple values, when this is the case there is no index (“Multi-Value” dimension special case);
   implemented as a measure with file name_id_<DimName>.mea.full.

### Measure

mea.full: [ ]{Value int}
   row id is implicit (array index +1);
   null values are represented by a special int (MinInt64: −0x8000000000000000);
   measures may be created and stored in compressed format .mea but can be read from decompressed .mea.full format.

In some embodiments, a database system may use various transformation binaries (e.g., “augment”) on one or more edgemart datasets (also referred to herein simply as “edgemarts”) as input and outputting a new edgemart. In one example, the augment transformation performs a left outer equijoin (a join with a join condition containing an equality operator that returns only the rows that have equivalent values for the specified columns) between two edgemarts (a “left” edgemart and a “right” edgemart) using one or more dimensions as keys, resulting in the left edgemart being “augmented” with dimensions and measures selected from the right edgemart.

In some embodiments, when a key from the left edgemart has no match, joined dimension and measure values are set to null. When more than one row in the right edgemart matches a key from the left edgemart, the system may perform a “single lookup” procedure that uses dimension and measure values from the first matching row, or a “multi lookup” procedure where the joined measure value is the sum of measure values from matchings rows and where the joined dimension is multi-valued with all values from matching rows.

Embodiments of the present disclosure may operate in conjunction with a variety of types of “augment” or “join” operations. For example, a database system implementing embodiments of the present disclosure may provide an “update” transformation, which is a special case of augment which can update values in existing dimensions and measures (when there is no match the original values are kept).

In some embodiments, the database system may be adapted to process database records (e.g., streaming and sorting) within a fixed amount of random-access memory (RAM). In such cases, excess data and files that would exceed the fixed amount of RAM may be “spilled over” to disk (e.g., written to a hard drive or other secondary memory in communication with the database system). The spill over data may be compressed to minimize disk input-output (IO) impact.

For example, the “measure” data described above for the “edgemart” data structure may be spilled over to secondary storage in compressed “.mea” format files. The database system may also access the contents of compressed data spilled over to secondary storage, such as by sequentially streaming data from the compressed “.mea” file format.

FIG. 2 illustrates an example of a dataset, while FIG. 3 illustrates an example of a data structure (an edgemart in this example) storing the data in the dataset of FIG. 2. In FIG. 2, the dataset “SalesRep” is represented as a table, though embodiments of the present disclosure may be implemented in conjunction with datasets in any desired format. Likewise, while the edgemart data structure is shown in FIG. 3, embodiments of the present disclosure may operate in conjunction with data stored in any other suitable data structure format.

As described above for the edgemart data structure, the data in table 200 in FIG. 2 is stored in the three data class formats (the “dat” and “index” dimensions and the measure format) in FIG. 3. In this example, the “dat” dimension is represented by table 305 with “Id” and “Name” fields. The “index” dimension comprises two integer tuple arrays 310, one for “Id” (based on “id_val_id”) and one for “Name” (based on “Name_val_id”). The “measure” field 315 includes an integer tuple array based on “Age.”

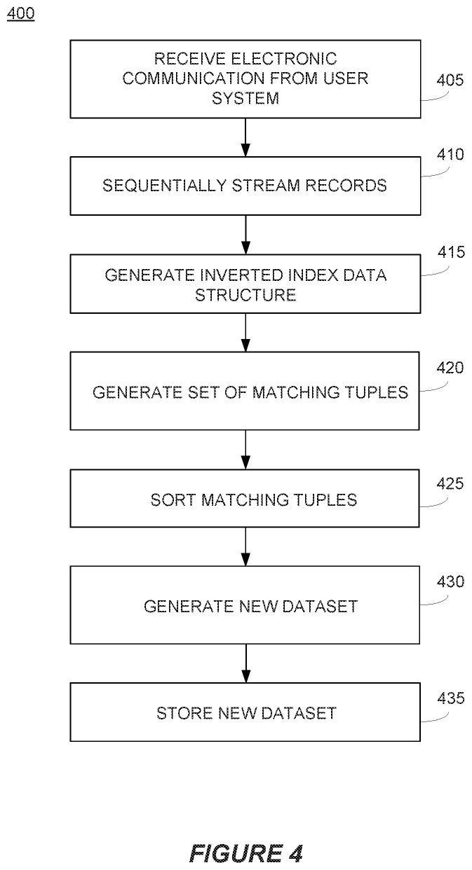

FIG. 4 is a flow diagram illustrating an example of a process 400 according to various aspects of the present disclosure. Any combination and/or subset of the elements of the methods depicted herein (including method 400 in FIG. 4) may be combined with each other, selectively performed or not performed based on various conditions, repeated any desired number of times, and practiced in any suitable order and in conjunction with any suitable system, device, and/or process. The methods described and depicted herein can be implemented in any suitable manner, such as through software operating on one or more computer systems. The software may comprise computer-readable instructions stored in a tangible computer-readable medium (such as the memory of a computer system) and can be executed by one or more processors to perform the methods of various embodiments.

In this example, process 400 includes receiving, from a user system in communication with the database system, an electronic communication identifying one or more datasets to stream data from, one or more key values, or other information and/or instructions (405); sequentially streaming records from one or more datasets electronically stored by the database system in one or more database files (410); generating, based on the streamed records, an inverted index data structure that maps respective content within the records to respective locations in the one or more database files (415); generating, based on the inverted index data structure and a key, a set of matching tuples (420); sorting the set of matching tuples based on the key (425); generating, based on the sorted set of matching tuples, a new dataset joining elements from different datasets (430); and storing the new dataset (435).

As described above, a database system (e.g., implemented by system 16 illustrated in FIGS. 1A and 1B) may exchange electronic communications with one or more user systems (e.g., user system 12 illustrated in FIGS. 1A and 1B), such as over a network (e.g., network 14 in FIGS. 1A and 1B). In method 400, database system 16 may receive an electronic communication (405) over network 14 from a user system 12 to identify one or more datasets to join/augment, a key value (e.g., for sorting data), settings, preferences, search terms, and/or other instructions. For example, a communication from a user system may explicitly identify two datasets (e.g., a “first dataset” and a “second dataset”) to be joined or augmented. Alternatively, the database system may use information provided by a user system (e.g., key words) to identify datasets to be joined.

Embodiments of the present disclosure may sequentially stream through one or more electronically-stored datasets (410) to, among other things, create matching integer tuples such as row ids, dimension value ids, measure values, and other values that can be represented as integers. The content mapped by the inverted index data structure may be in any suitable format, including text strings, alphanumeric strings, numeric values, or combinations thereof. The database records from the dataset(s) may be streamed within a fixed amount of RAM (e.g., on database system 16), wherein data exceeding the fixed memory threshold is written to a hard drive (or other secondary storage) in communication with the database system 16.

In method 400, the system generates one or more inverted index data structures (415) that map respective content within the streamed records to respective locations. The system further generates, based on the inverted index data structure(s) and one or more keys, a set of matching tuples (420) and sorts the set of matching tuples (425) based on the key(s). The sorted lists of integer tuples may be based on row ids, dimension value ids, measure values, and other values that can be represented as integers. For example, content such as an alphanumeric string (e.g., “ABCDEFG12345”) may be mapped by the inverted index data structure to a location corresponding to the string in the database record (e.g., a row identifier) that can be represented as an integer value (e.g., row number 1).

As described in more detail below, embodiments of the present disclosure may perform a variety of different join or augment operations. These include, for example, “single lookup, single key,” “single lookup, composite key,” “multi-lookup, single key,” and “multi lookup, composite key” join/augment operations. In the following description of these augment algorithms the notation: “(c1, c2, . . . , cn)” is used to denote list of tuples with an implicit ordering, sorted by columns c1, . . . , cn, where underlined column names (such as “c2” in the example above) correspond to columns with unique values.

Embodiments of the present disclosure may operate in conjunction with data structures that are logically equivalent to sorted tuple lists, such as the edgemart data structure described above. For example, the “dat” field of the edgemart structure may be represented as: dat: (ValueId, StringValue, RowId), where ValueId is implicit (a zero-based StringValue number). The “dat” field can be built in bounded memory when values and row ids are streamed from a dataset in a sequential order. A RowId can appear multiple times when a row has multiple values. Similarly the “index” field of the edgemart data structure can be represented as: index: (RowId, ValueId), while the “measure” field can be represented as: mea.full: (RowId, IntValue).

The system may sort sets of matching tuples (425) and join datasets to generate new datasets (430) based on one or more keys and according to a variety of different sorting algorithms. In some embodiments, for example, the sorting of tuples in bounded memory (e.g., within a fixed amount of RAM on the system) may be performed using a radix sort process, with a time complexity of O(n). Sorting tuples that are spilled over to disk (or other secondary storage outside of RAM) may be performed using an external merge sort with a time complexity O(n log(n)). Similarly, Tuple lists sorted by the same key can be joined in bounded memory as well using a merge join process from data spilled over to secondary storage. Sorted tuple lists may also be read in a streaming manner to also create new dataset in a memory-bound fashion.

In some embodiments, the system may sort a “chunk” of integer tuples (425) in memory (e.g., RAM) before flushing the chunk to a hard disk or other secondary storage. In some embodiments, the integer tuples may be sorted using a quicksort algorithm. Consider N=the total of rows and M=the maximum rows in memory, then there are N/M chunks and the quicksort algorithm may have an efficiency of: N/M*O(M*log M)->O(N). Furthermore, sorted chunk files may be merged using a heap sort algorithm having an efficiency of: N*O(log(N/M))->O(N*log N). In this example, the total combined efficiency would thus be: Total cost: O(N)+O(N*log N)->O(N*log N). In some cases, integer tuples may be sorted in memory using a radix sort algorithm, which may be faster on the integers from the generated inverted index data structure than a quicksort algorithm.

New datasets generated by joining existing datasets may be stored (435) in new or existing database files. In some embodiments, for example, a new dataset generated by joining a first/left and second/right dataset may be stored in the same database file containing the first/left and/or second/right dataset.

Consider an example of performing a “single lookup, single key” join operation on the following two datasets, a “first” or “Left” dataset and a “second” or “Right” dataset, both shown below. In this example, the system will augment Right to Left based on keys JoinKeyA+JoinKeyB, bringing in “NewColumn.”

| Row | JoinKeyA |
|---|---|
| 1 | A |
| 2 | B |
| 3 | A |
| 4 | B |
| 5 | C |

| Row | JoinKeyB | NewColumn |
|---|---|---|
| 1 | B | Yes |
| 2 | B | No |
| 3 | C | Maybe |
| 4 | C | No |
| 5 | A | Yes |

In these examples, the first/left dataset has two columns and the second/right dataset has three columns. The system may stream these datasets (410) and generate an inverted index data structure (415) for each dataset. The inverted index data structures for the left and right data sets are shown below, with key values (e.g., A, B, or C) represented using their respective row number integers:

### Left:

### JoinKeyA

### A: 1,3

### B: 2,4

### C: 5

### Right:

### JoinKeyB

### A: 5

### B: 1,2

### C: 3,4

Similarly, the reverse/inverted index data structure for the third column (“NewColumn”) is represented using row number integers corresponding to the three possible string values in the dataset (“Maybe,” “No,” and “Yes”):

### NewColumn

### Maybe: 3

### No: 2,4

### Yes: 1,5

In this example, the system performs a single key, single lookup join process as follows:
Map rows:
   merge-join left and right keys' dats on value, only retaining first match from the right->JoinRowMap: (LeftRowId, RightRowId).
Join right dimension:
   merge-join JoinRowMap and dim index on RightRowId->(LeftRowId, RightDimValueId).
   merge-join with dat on RightDimValueId to get actual values->new left dat: (LeftDimValue, LeftRowId).
Join right measure:
   merge-join JoinRowMap with right mea.full on RightRowId->(LeftRowId, IntValue)->new left measure (use null value for unmatched left rows).

Using the Left and Right datasets introduced above, the system maps the rows and constructs the JoinRowMap by determining, for each left row, from which row should the system drive the index lookup to find the value for the column being augmented. The JoinRowMap using the left and right datasets above would thus be as follows:

(leftjoinkeyrow, rightjoinkeyrow)
(1,5)
(3,5)
(2,1)
(4,1)
(5,3)

The system may then sort the list by the rightjoinkeyrow values:

(leftjoinkeyrow, rightjoinkeyrow)
(2,1)
(4,1)
(5,3)
(1,5)
(3,5)

The system may then iterate the rightjoinkeyrow values and lookup the corresponding valuelD to augment:

(leftjoinkeyrow, right augment column value id)
(2,3)
(4,3)
(5,1)
(1,3)
(3,3)

The system may then sort again based on the “right augment column value id”:

(leftjoinkeyrow, right augment column value id)
(5,1)
(1,3)
(2,3)
(3,3)
(4,3)

The system may then look up the actual string values for the third column (1=“Maybe”; 2=“No”; 3=“Yes”), and create recordsets by merging rows:

### Maybe: 5

### Yes: 1,2,3,4

The system may generate (430) and store (435) a new dataset based on the preceding example. In this case, the new dataset generated would be as follows:

| Row | JoinKeyA | NewColumn |
|---|---|---|
| 1 | A | Yes |
| 2 | B | Yes |
| 3 | A | Yes |
| 4 | B | Yes |
| 5 | C | Maybe |

In other cases, the system may perform a single lookup with composite/multi keys (e.g., keys 1 . . . k) join process. In such cases, the join process may include:
Map rows:
   merge-join left and right keys dat on value->(RightRowId,LeftKey1ValueId) . . . (RightRowId, LeftKeyKValueId).
   merge-join on RightRowId->RightKeys: (LeftKey1ValueId, . . . , LeftKeyKValueId, RightRowId).
   merge-join left keys indexes on LeftRowId->LeftKeys: (LeftKey1ValueId, . . . , LeftKeyKValueId, LeftRowId).
   merge join LeftKeys and RightKeys, only retaining first match from the right->JoinRowMap: (RightRowId, LeftRowId).
Join right dimensions and measures
   use JoinRowMap similarly to single key case.

In another example, the system may perform a multi-lookup, single key join procedure. In this example, embodiments of the present disclosure may perform the multi-lookup, single key process by either: (1) materializing all matches (referred to below as “Option 1”); or (2) generating Cartesian products on the fly (referred to below as “Option 2”). In some cases, the system may choose Option 1 when there are many key values with few matching rows per key value, and may choose Option 2 when there are few key values with many matching rows per key value. The two options are described below:

Option 1, materialize all matches:
Same as single lookup, but create JoinRowMap with all matches from the right instead of just the first one.
This option can be inefficient when are many matches for each key, e.g. degenerate worst case when key is a constant causes a Cartesian product between left and right edgemarts to be materialized in JoinRowMap.
Worst case efficiency will be O(n*n).
   Option 2, generate cartesian products on the fly:
Map rows
   Left and Right maps kept independent to avoid materializing combinatorial explosions.
   merge-join left and right key dats on Value, use value ids from left as a reference for matching.
      LeftMatchedKeys: (LeftKeyValueId, LeftRowId)
      RightMatchedKeys: (RightRowId, LeftKeyValueId)
Join right dimension
   merge-join right dim index and RightMatchedKeys on RightRowId
      (RightDimValueId, LeftKeyValueId).
   iterate, for each RightDimValueId:
      for each leftKeyValueId read bytearray from left key dat.
      union all left key byte arrays in memory on the fly.
      add StringValue and byte array to left dim dat.
Join right measure
   merge join RightMatchedKeys w/mea.full on RightRowId:
      (LeftKeyValueId, IntValue).
   reduce:
      (LeftKeyValueId, sum(IntValue)).
   merge join with LeftMatchedKeys on LeftKeyValueId
      (LeftRowId, sum(IntValue)).

In some embodiments, the system may analyze datasets and choose whether to perform Option 1 or Option 2 based on the characteristics of the data being processed. In other embodiments, the system may start with Option 2 and determine the number of row matches subsequent to the left and right join being calculated. If the number of row matches is below a predetermined threshold (e.g., less than 2e9), the system may combine left and right join maps into single join map and fall back to Option 1, or continue with Option 2 otherwise.

In a specific example of the multi-lookup, single key join process described above, consider the datasets introduced for the preceding single key, single lookup example. For multi-lookup, single key joining, the system constructs the JoinRowMap as follows (the bolded elements being additional to the JoinRowMap from the previous example since all values are being looked up, not just the first value):

(leftjoinkeyrow, rightjoinkeyrow)
(1,5)
(3,5)
(2,1)
(4,1)
(2,2)
(4,2)
(5,3)
(5,4)

Likewise, the new dataset formed from joining the Left and Right datasets includes multiple values on the right (in contrast to single lookup where only the first value is looked up). The new data set in for multi-lookup, single key joining described above would thus be:

| Row | JoinKeyA | NewColumn |
|---|---|---|
| 1 | A | Yes |
| 2 | B | Yes, No |
| 3 | A | Yes |
| 4 | B | Yes, No |
| 5 | C | Maybe, Yes |

Embodiments of the present disclosure may also perform multi-lookup, composite key join operations, which result in the same output as single lookup, composite key joining except every match from the right dataset is retained instead of just the first match. Embodiments of the present disclosure may also perform “update” operations, which is a special case of augment that can update values in existing dimensions and measures (when there is no match the original values are kept). An example of an update process is as follows:
Map rows
   build JoinRowMap: (RightRowId, LeftRowId) similar to non-update cases.
   derive all rows from left which have no match->LeftUnmatchedRows: (LeftRowId).
Join right dimension
   merge-join left dim index and LeftUnmatchedRows on LeftRowId:
      LeftValues: (LeftDimValueId, LeftRowId).
   merge join right dim index and JoinRowMap on RightRowId:
      RightValues: (RightDimValueId, LeftRowId).
   4 way merge-join left dat, LeftValues, RightValues, right dat on DimValue
      build new dat file using dim value.
      value only exists left->build byte array from LeftValues row ids.
      value only exists right->build byte array from RightValues row ids.
      value exists on both sides->union row ids from left and right.
Join right measure
   same as non update case, except behavior when left row is unmatched: use original left measure value instead of null

Some embodiments of the present disclosure may operate in conjunction with multi-value dimensions (e.g., as described above with reference to the “edgemart” data structure). For example, the system may materialize each (valueId, rowId) of the multi-value dimension.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which an on-demand database service environment is implemented in a system having an application server providing a front end for an on-demand database service capable of supporting multiple tenants, the present implementations are not limited to multi-tenant databases or deployment on application servers. Implementations may be practiced using other database architectures, i.e., ORACLE®, DB2® by IBM and the like without departing from the scope of the implementations claimed.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Additionally, any of the software components or functions described in this application can be implemented as software code to be executed by one or more processors using any suitable computer language such as, for example, Java, C++ or Perl using, for example, existing or object-oriented techniques. The software code can be stored as a computer- or processor-executable instructions or commands on a physical non-transitory computer-readable medium. Examples of suitable media include random access memory (RAM), read only memory (ROM), magnetic media such as a hard-drive or a floppy disk, or an optical medium such as a compact disk (CD) or DVD (digital versatile disk), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While some implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A database system comprising:
a processor; and
memory coupled to the processor and storing instructions that, when executed by the processor, cause the database system to perform operations comprising:
sequentially streaming records from a first dataset and a second dataset electronically stored by the database system in one or more database files;
generating, based on the records from the first dataset and the second dataset, an inverted index data structure that maps respective content within the records to respective locations in the one or more database files;
generating, based on the inverted index data structure and a key, a set of matching tuples;
sorting the set of matching tuples based on the key; and
generating, based on the sorted set of matching tuples, a new dataset joining elements from the first dataset and the second dataset.

2. The database system of claim 1, wherein the memory further stores instructions for causing the database system to receive, from a user system in communication with the database system, an electronic communication identifying one or more of: the first dataset, the second dataset, and the key value.

3. The database system of claim 1, wherein content mapped by the inverted index data structure includes: a text string, an alphanumeric string, a numeric value, or combinations thereof.

4. The database system of claim 1, wherein the locations to which content is mapped by the inverted index data structure correspond to integer values.

5. The database system of claim 4, wherein the set of matching tuples are integer tuples associated with one or more of: a row identifier, a dimension value identifier, and a measure value.

6. The database system of claim 1, wherein the memory further stores instructions for causing the database system to store the new dataset in the one or more database files.

7. The database system of claim 6, wherein the new dataset is stored in a database file containing one or more of the first dataset and the second dataset.

8. The database system of claim 1, wherein sequentially streaming the records and sorting the set of matching tuples is performed within a fixed amount of random access memory (RAM), and wherein data exceeding the fixed amount of RAM is written to a hard drive in communication with the database system.

9. The database system of claim 8, wherein the data written to the hard drive is compressed.

10. The database system of claim 8, wherein data within the fixed amount of RAM is sorted using a radix sort process, and wherein data written to the hard drive is sorted using a merge sort process.

11. A tangible, non-transitory computer-readable medium storing instructions that, when executed by a database system, cause the database system to perform operations comprising:
sequentially streaming records from a first dataset and a second dataset electronically stored by the database system in one or more database files;
generating, based on the records from the first dataset and the second dataset, an inverted index data structure that maps respective content within the records to respective locations in the one or more database files;
generating, based on the inverted index data structure and a key, a set of matching tuples;
sorting the set of matching tuples based on the key; and
generating, based on the sorted set of matching tuples, a new dataset joining elements from the first dataset and the second dataset.

12. The computer-readable medium of claim 11, wherein the medium further stores instructions for causing the database system to receive, from a user system in communication with the database system, an electronic communication identifying one or more of: the first dataset, the second dataset, and the key value.

13. The computer-readable medium of claim 11, wherein the locations to which content is mapped by the inverted index data structure correspond to integer values.

14. The computer-readable medium of claim 13, wherein the set of matching tuples are integer tuples associated with one or more of: a row identifier, a dimension value identifier, and a measure value.

15. The computer-readable medium of claim 11, wherein the memory further stores instructions for causing the database system to store the new dataset in the one or more database files

16. The computer-readable medium of claim 15, wherein the new dataset is stored in a database file containing one or more of the first dataset and the second dataset.

17. The computer-readable medium of claim 11, wherein sequentially streaming the records and sorting the set of matching tuples is performed within a fixed amount of random access memory (RAM), and wherein data exceeding the fixed amount of RAM is written to a hard drive in communication with the database system.

18. The computer-readable medium of claim 17, wherein the data written to the hard drive is compressed.

19. The computer-readable medium of claim 17, wherein data within the fixed amount of RAM is sorted using a radix sort process, and wherein data written to the hard drive is sorted using a merge sort process.

20. A method comprising:
sequentially streaming records, by a database system, from a first dataset and a second dataset electronically stored by the database system in one or more database files;
generating, by the database system based on the records from the first dataset and the second dataset, an inverted index data structure that maps respective content within the records to respective locations in the one or more database files;
generating, by the database system based on the inverted index data structure and a key, a set of matching tuples;
sorting, by the database system, the set of matching tuples based on the key; and
generating, by the database system based on the sorted set of matching tuples, a new dataset joining elements from the first dataset and the second dataset.
